(19) United States
(12) Patent Application Publication
(10) Pub. No.: US 2016/0007522 A1
(43) Pub. Date: Jan. 14, 2016

(54) CONTINUOUS WINDROW MERGER

(71) Applicant: RCI Engineering LLC, Mayville, WI (US)

(72) Inventors: Randall J Clark, Mayville, WI (US); Russell J Kempf, Kewaskum, WI (US)

(21) Appl. No.: 14/859,330

(22) Filed: Sep. 20, 2015

Related U.S. Application Data
(62) Division of application No. 14/218,717, filed on Mar. 18, 2014.
(60) Provisional application No. 61/799,529, filed on Mar. 15, 2013.

(51) Int. Cl. A01B 73/04; A01D 57/20; A01D 57/28

(52) U.S. Cl. CPC A01B 73/04; A01D 57/28; A01D 57/20

(57) ABSTRACT

A continuous windrow merger has a frame that supports center, right and left pickup assemblies. The pickup assemblies each include a pickup head and a conveyor assembly. The pickup head has a cylindrical reel and a plurality of tines extending radially outwardly from the reel. The pickup head is arranged to pickup and deliver crop material rearward to the conveyor assembly. The conveyor assembly has a draper belt with an upper surface arranged to receive crop material from the pickup head and transfer the crop material in a lateral direction. The draper belt is mounted with the upper surface sloping downwardly and rearwardly from the pickup head. The merger has a folded configuration for transport in which the right and left wing frame sections extend generally vertically above the center frame section. The frame can be attached to the front of a self-propelled traction unit or towed behind a tractor.

### RELATED APPLICATIONS

This application is a divisional of U.S. patent application Ser. No. 14/218,717 filed on Mar. 18, 2014, which claimed the benefit of U.S. Provisional Patent Application No. 61/799,529 filed on Mar. 15, 2013. The entire contents of these parent applications are incorporated herein by reference.

### BACKGROUND OF THE INVENTION

1. Field of the Invention

The present invention relates generally to windrow mergers and methods for merging windrows into a single windrow for baling or harvesting.

2. Description of the Related Art

Devices for merging windrows are commonly used to gather material, such as cut hay, and merge the material into a single windrow for harvesting or baling. For large scale operations requiring windrow merging on large fields, it is often desired to have a relatively large width to merge the material at a fast rate during a short timeframe when conditions are favorable.

The size of merger devices has been limited by the towing capacity of tractors and other propulsion devices, width limitations for transport on public highways, weight limitations, and conveying system capacity. As larger tractors and propulsion devices have developed, there is a need for windrow merging devices that provide for a wide pickup area to achieve a high merging capacity, while still being capable of folding to a sufficiently narrow width for highway transport and storage.

A windrow merger device having multiple sections for increased width is described in U.S. Pat. No. 8,166,739 issued to Dow et al. However, Dow et al.'s merger device requires a large rear frame for folding the wing sections back and around. The large frame adds weight, which increases cost and soil compaction.

Conventional pickup assemblies for mergers have pickup tines on bars that are mounted on a reel. The ends of the bars have a cam follower with a bearing at the outside. The bearing follows a cam profile or track to turn the tine to different positions throughout the rotation of the reel. The conventional pickup assembly is therefore complex and requires a high number of bearings and moving parts, as well as increased weight.

A new and improved windrow merging device is needed that overcomes the disadvantages with the conventional windrow merging devices described above.

### SUMMARY OF THE INVENTION

An object of the present invention is to provide a continuous windrow merger that has improved crop flow from the pickup assembly onto the draper belt, thereby allowing a simpler, cam-less pickup assembly to be used.

A further object of the present invention is to provide a windrow merger with a cam-less pickup assembly that reduces the number of bearings, components and weight of the pickup assembly.

A further object of the present invention is to provide a lateral folding configuration for a multi-section merger device that reduces the structure of the merger frame, thereby reducing weight, cost and soil compaction.

A further object of the present invention is to provide a windrow merger having a modular design that allows the same merger unit to be configured as a self- propelled unit or a pull-behind unit.

A further object of the present invention is to provide a pickup head having a pattern of tines mounted to a cylindrical reel that reduces the load on the motors and makes more even crop flow.

To accomplish these and other objects of the present invention, a continuous windrow merger is provided that has a frame arrangement supporting center, right and left pickup assemblies. The pickup assemblies each include a pickup head and a conveyor assembly. The pickup head has a cylindrical reel and a plurality of tines mounted rigidly to the reel and extending radially outwardly from the reel. The pickup head is arranged to pickup and deliver crop material rearward to the conveyor assembly. The conveyor assembly has a draper belt with an upper surface arranged to receive crop material from the pickup head and transfer the crop material in a lateral direction. The draper belt is mounted with the upper surface sloping downwardly and rearwardly from the pickup head. The merger has a folded configuration for transport in which the right and left wing frame sections extend generally vertically above the center frame section. The frame can be attached to the front of a self-propelled traction unit or towed behind a tractor.

According to one aspect of the invention, a windrow merger is provided, comprising: a frame; a first pickup assembly supported by the frame, the first pickup assembly comprising a pickup head and a conveyor assembly; the pickup head comprising a cylindrical reel and a plurality of tines extending radially outwardly from the reel, the pickup head being arranged to pickup and deliver crop material rearward to the conveyor assembly; and the conveyor assembly comprising a draper belt with an upper surface arranged to receive crop material from the pickup head and transfer the crop material in a lateral direction, the draper belt being mounted with the upper surface sloping downwardly and rearwardly from the pickup head.

According to another aspect of the present invention, a windrow merger is provided comprising: a frame having a center frame section and right and left wing frame sections, the right wing frame section being pivotally attached to a right side of the center frame section for folding movement about a first longitudinal folding axis, and the left wing frame section being pivotally attached to a left side of the center frame section for folding movement about a second longitudinal folding axis; a center pickup assembly comprising a pickup head and conveyor assembly supported by the center frame section; a right wing pickup assembly comprising a pickup head and conveyor assembly supported by the right frame section; and a left wing pickup assembly comprising a pickup head and conveyor assembly supported by the left frame section. The merger has an unfolded configuration for field operations in which the right and left wing frame sections extend generally horizontally outwardly from outer ends of the center frame section, and a folded configuration in which the right and left wing frame sections extend generally vertically above the center frame section.

According to another aspect of the present invention, a convertible windrow merger is provided comprising: a frame; a pickup assembly comprising a pickup head and conveyor assembly supported by the frame; and a means for converting the frame between a first configuration for attaching to a front of a self-propelled traction unit for use as a self-propelled merger, and a second configuration for attaching behind a tractor for use as a pull behind merger.

Numerous other objects of the present invention will be apparent to those skilled in this art from the following description wherein there is shown and described an embodiment of the present invention, simply by way of illustration of one of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the invention is made with reference to the accompanying drawings. In the drawings:

FIG. 1 is a perspective view of a continuous merger according to the present invention in a first configuration in which the merger is mounted to the front of a self- propelled traction unit.

FIG. 2 is another perspective view of the self-propelled merger shown in FIG. 1.

FIG. 3 is a side elevation view of the self-propelled merger shown in FIG. 1.

FIG. 4 is a perspective view of the continuous merger of the present invention in a second configuration in which the merger has a hitch tongue and support wheels for being pulled behind a tractor.

FIG. 5 is another perspective view of the pull-behind merger shown in FIG. 4.

FIG. 6 is a side elevation view of the pull-behind merger shown in FIG. 4.

FIG. 7 is a perspective view of the merger of the present invention in a folded configuration for transport.

FIG. 8 is a rear elevation view of the folded merger shown in FIG. 7.

FIG. 9 is a perspective detail view of the pivot arrangement used between the center frame section and the wing frame sections of the merger, with the wing frame sections in their folded configuration.

FIG. 10 is a rear elevation detail view of the pivot arrangement between the center frame section and one of the wing frame sections, with the wing frame section in its folded configuration.

FIG. 11 is a rear elevation detail view of the pivot arrangement between the center frame section and one of the wing frame sections, with the wing frame section in its unfolded configuration.

FIG. 12 is a perspective view of one of the pickup assemblies used in the merger of the present invention, with the draper belt removed.

FIG. 13 is a front elevation view of the pickup assembly shown in FIG. 12.

FIG. 14 is a top view of the pickup assembly shown in FIG. 12.

FIG. 15 is a perspective view of one of the end roller assemblies used to support the draper belt in the pickup assemblies of the present invention.

FIG. 16 is a top view of the end roller assembly shown in FIG. 15.

FIG. 17 is a side elevation view of the end roller assembly shown in FIG. 15.

FIG. 18 is a perspective view of one of the pickup assemblies with the draper belt shown.

FIG. 19 is a side elevation elevation view of the pickup assembly shown in FIG. 18.

FIG. 21 is a top view of the pickup assembly shown in FIG. 18.

FIG. 22 is a perspective view of a pickup head comprising a cylindrical reel and a plurality of tines extending outwardly from the real.

FIG. 23 is a partially exploded perspective view of a portion of the pickup head shown in FIG. 22.

FIG. 24 is a side elevation view of a tine assembly for use with the pickup head of the present invention.

FIG. 25 is a front elevation view of the tine assembly shown in FIG. 24.

FIG. 26 is a perspective view of the tine assembly shown in FIGS. 24 and 25.

### DETAILED DESCRIPTION OF THE INVENTION

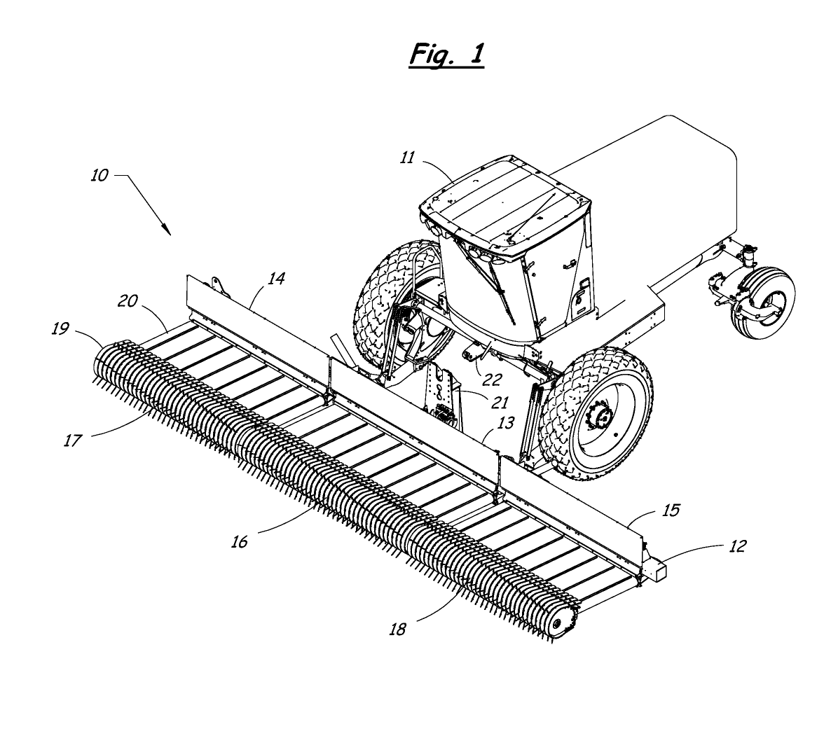

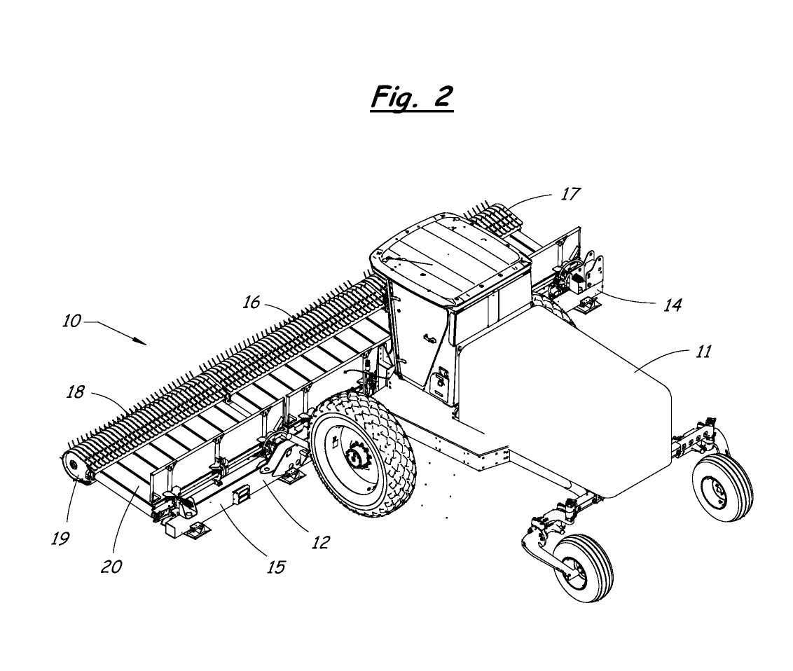

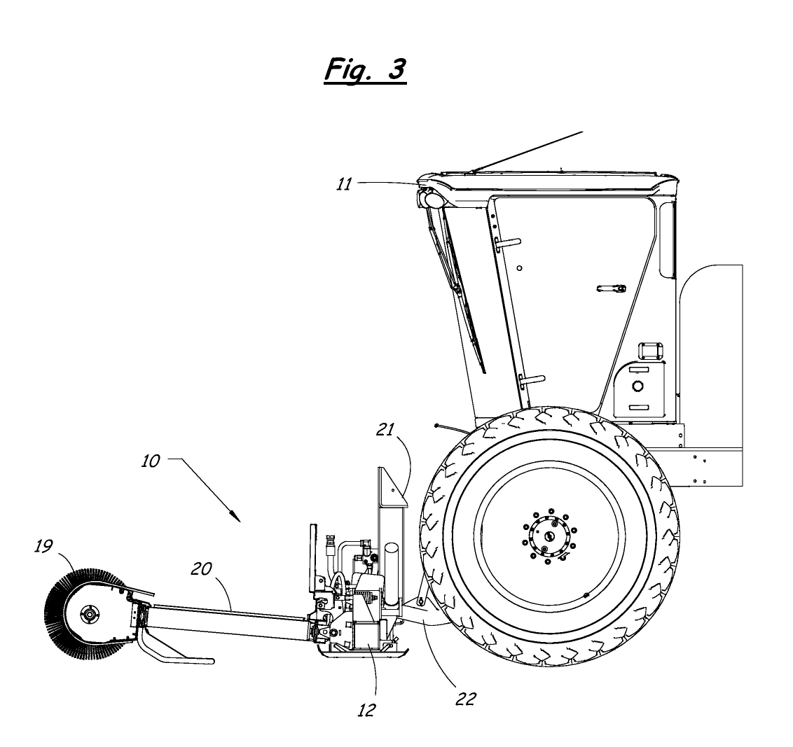

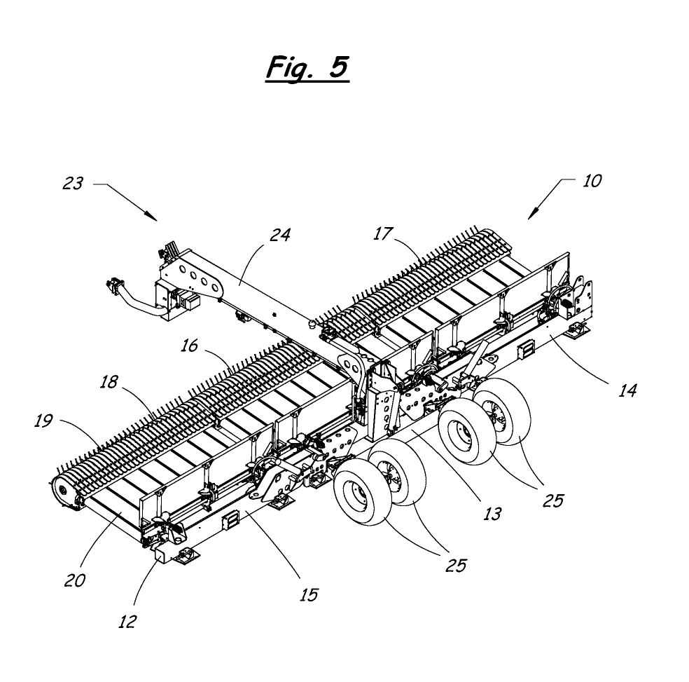

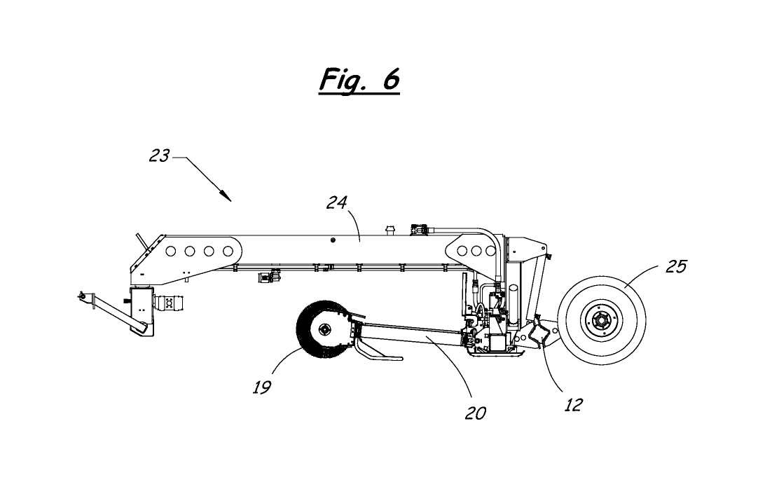

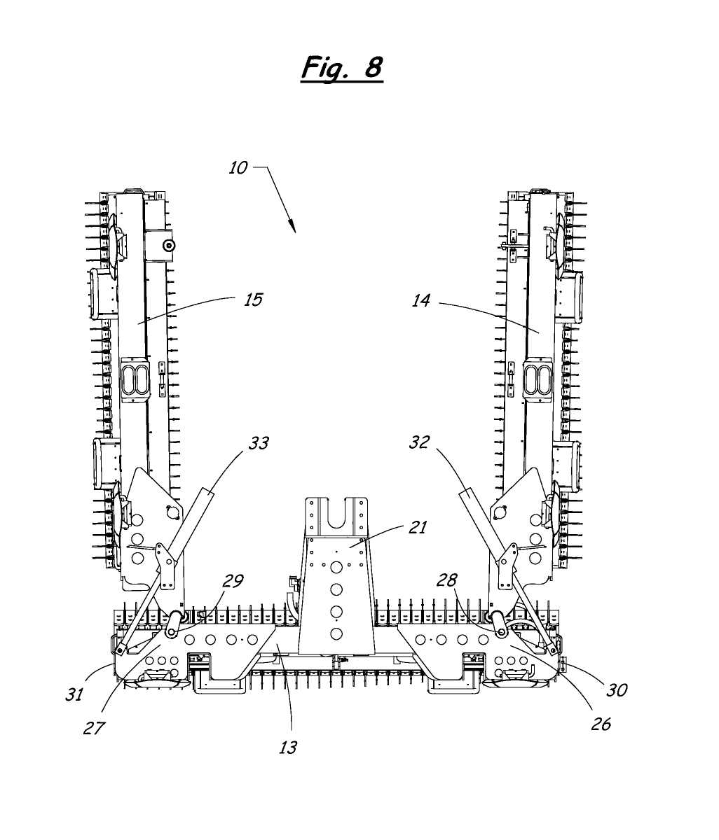

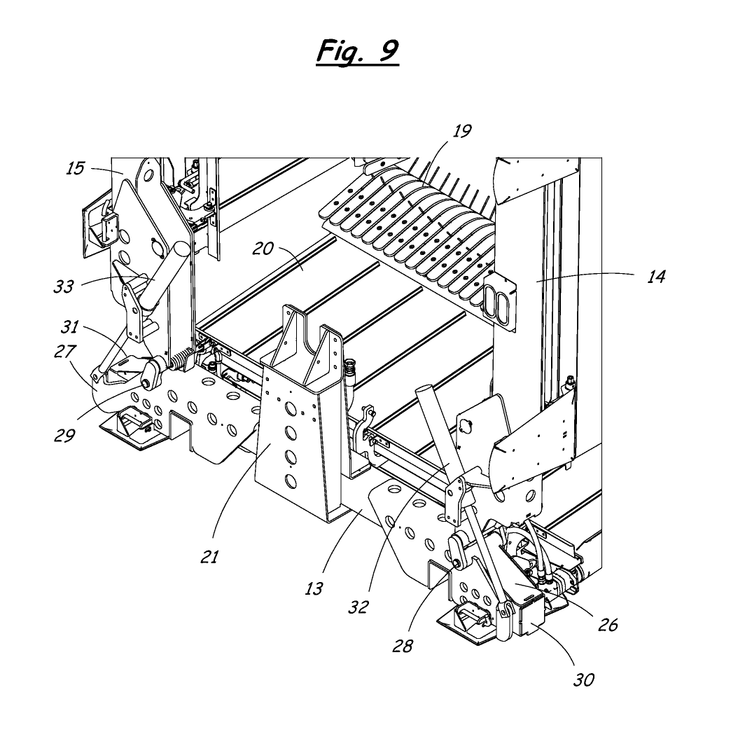

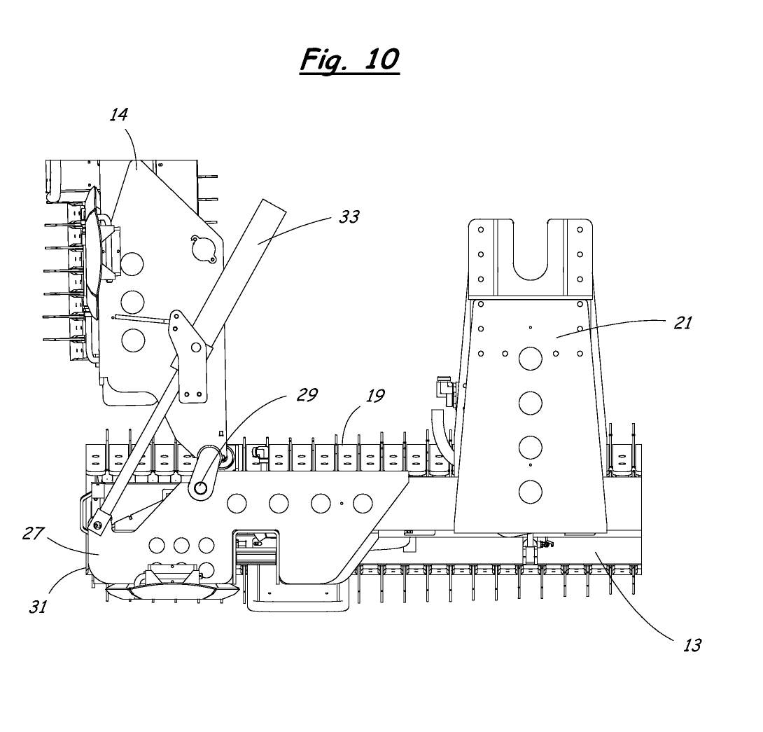

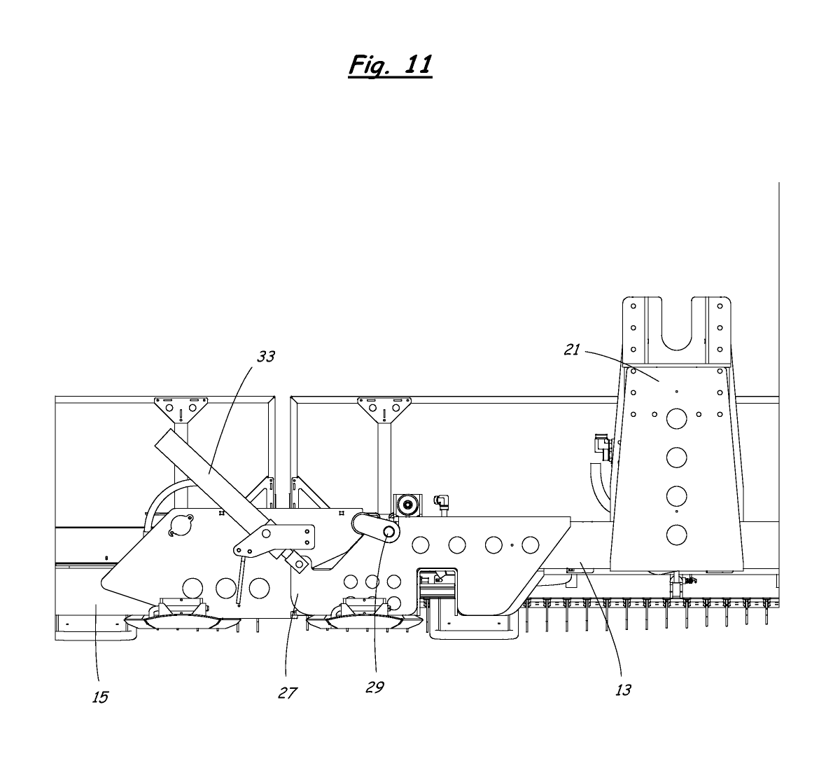

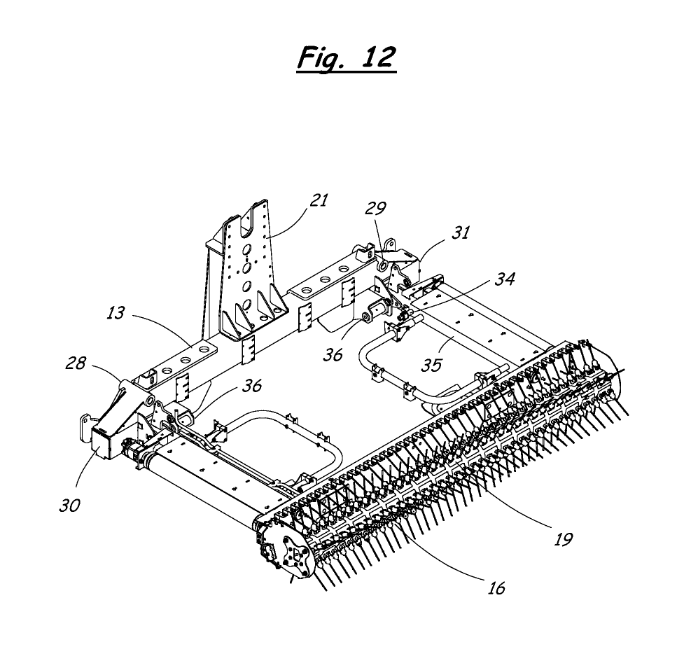

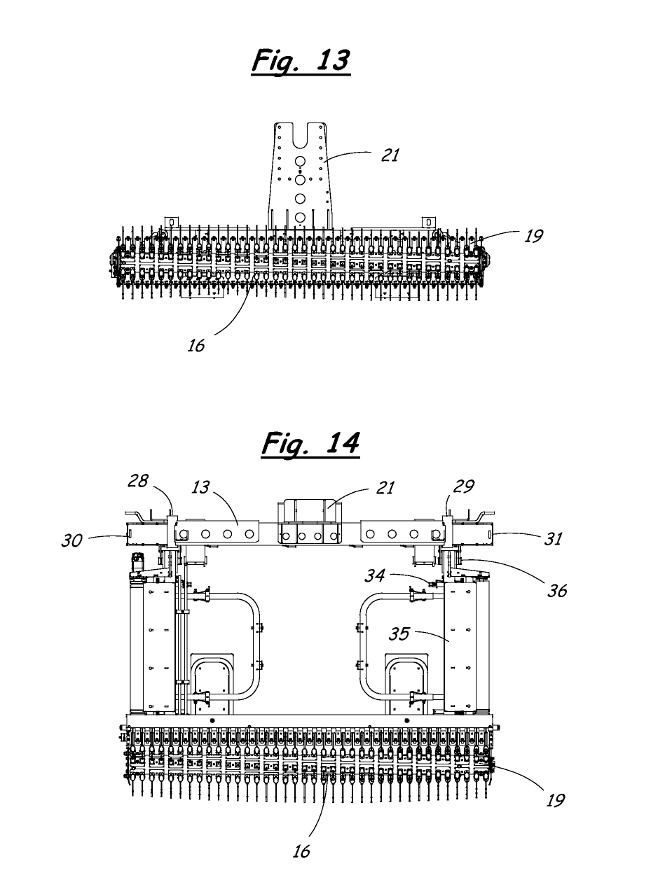

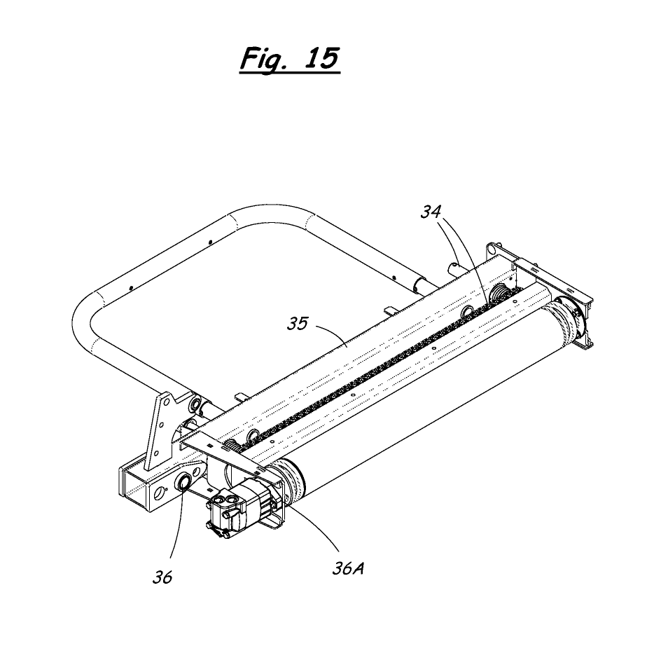

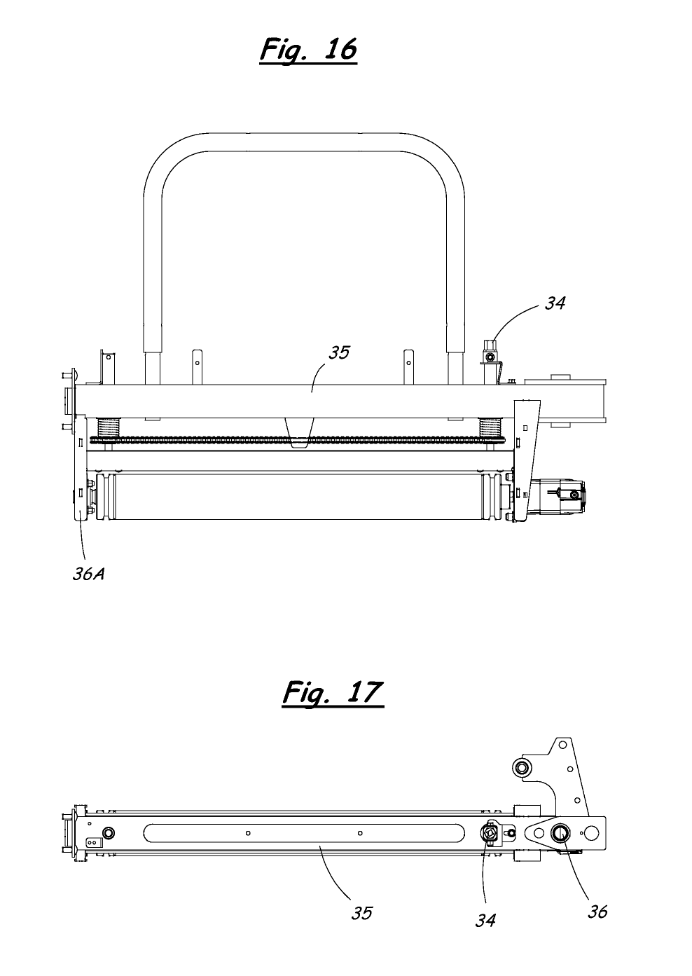

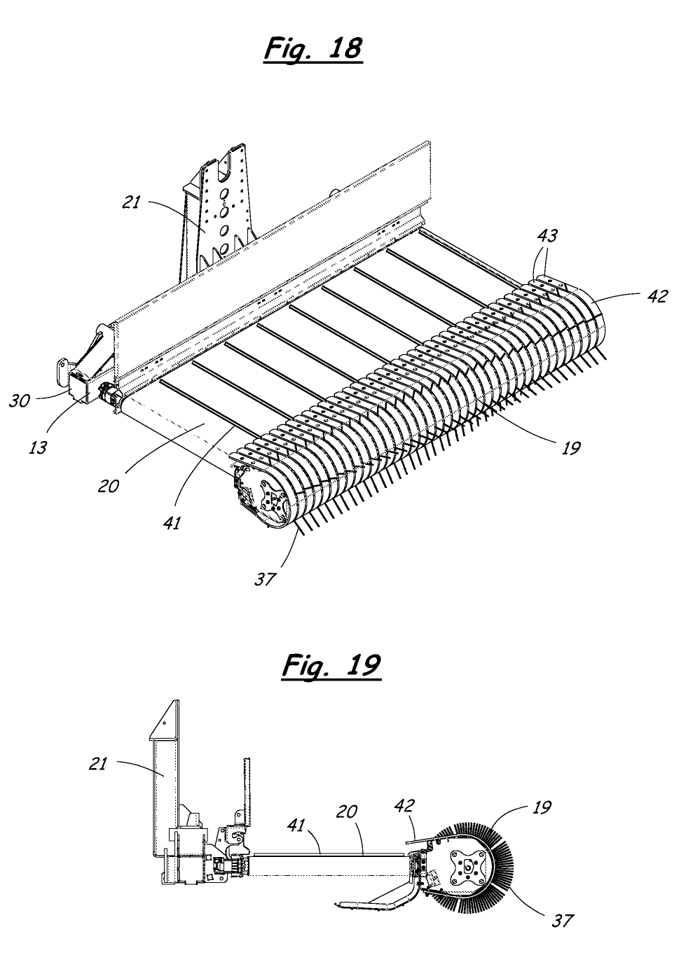

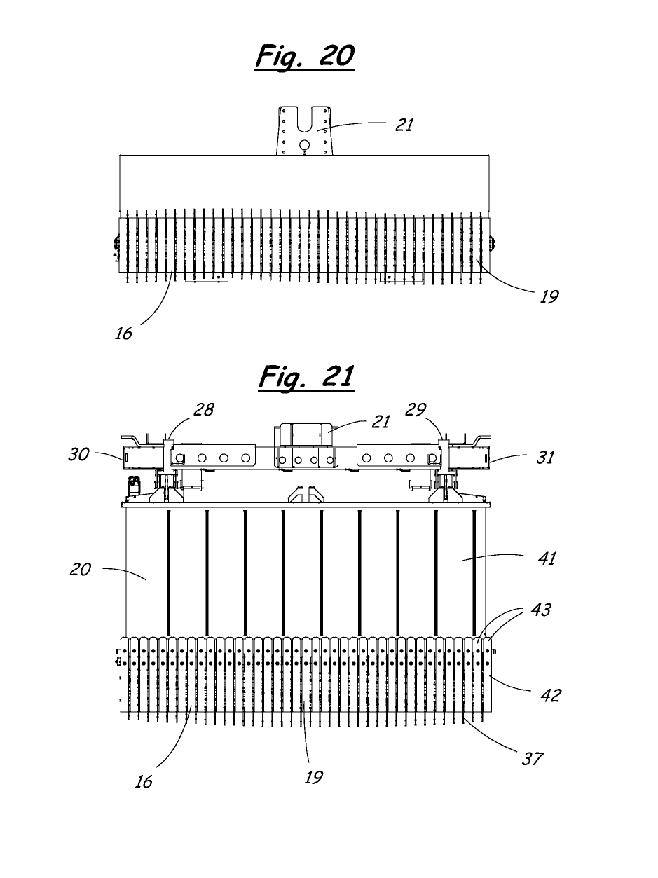

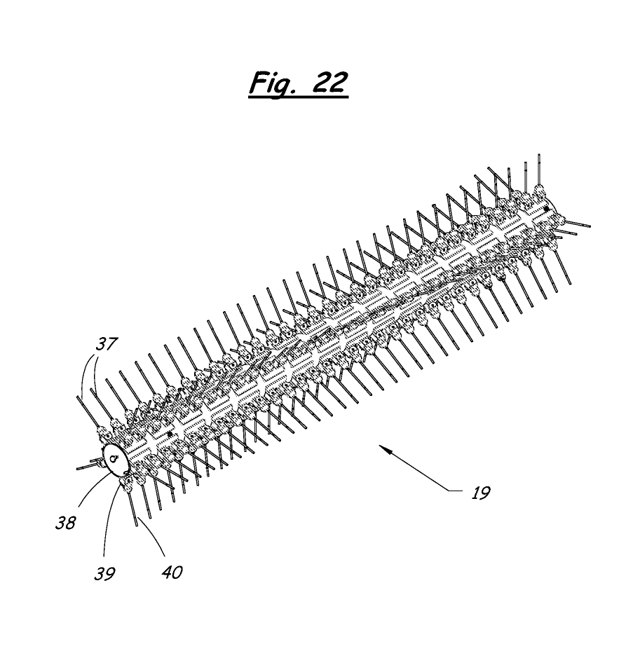

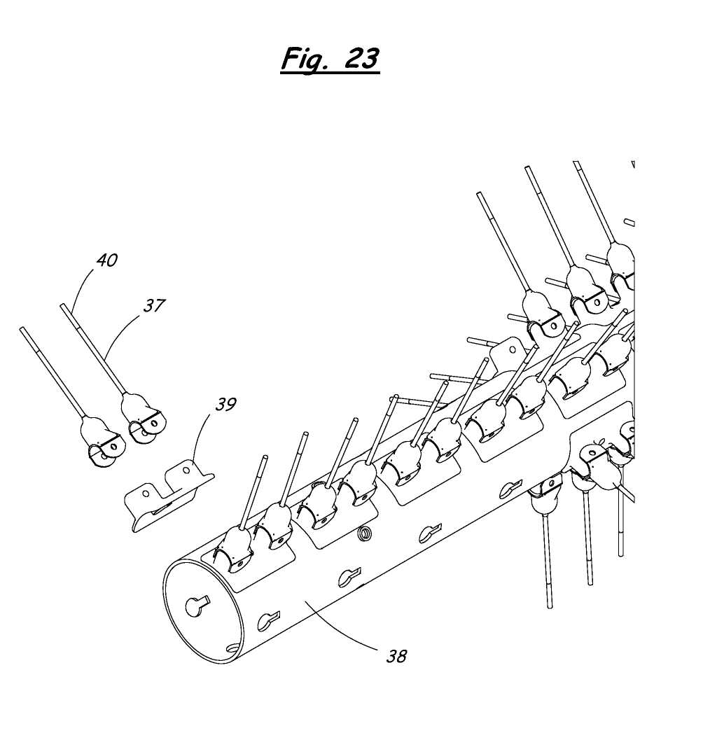

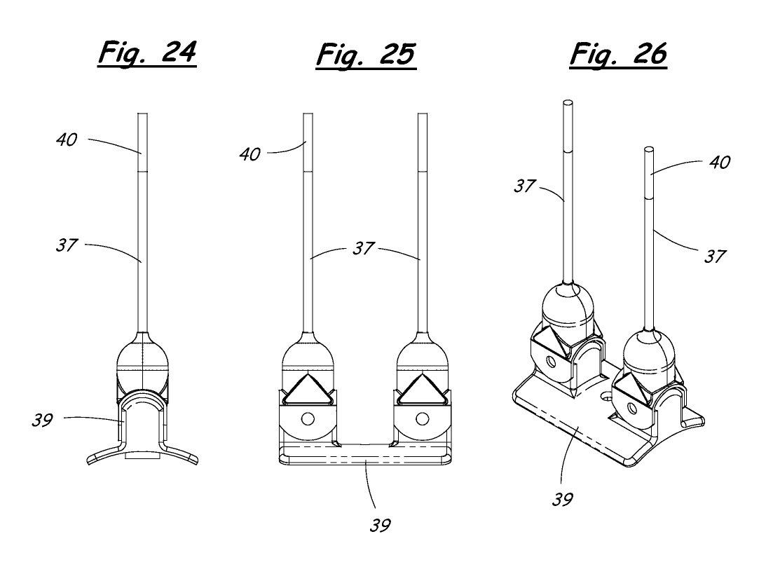

A windrow merger 10 according to the present invention will be described with reference to FIGS. 1 to 26 of the accompanying drawings.

The windrow merger 10 shown in FIGS. 1 to 3 is attached to the front of a self-propelled traction unit 11 for use as a self-propelled merger. The merger 10 includes a frame 12 having a center frame section 13 and right and left wing frame sections 14, 15. A center pickup assembly 16 is supported by the center frame section 13, a right wing pickup assembly 17 is supported by the right wing frame section 14, and a left wing pickup assembly 18 is supported by the left wing frame section 15.

Each pickup assembly 16, 17, 18 has a pickup head 19 and a conveyor assembly 20. The pickup head 19 is arranged to pickup and deliver crop material rearward to the conveyor assembly 20. The conveyor assembly 20 is arranged to receive crop material from the pickup head 19 and transfer the crop material in a lateral direction to a lateral side of the merger 10. The merger 10 can be operated to transfer crop material to either lateral side by changing a direction of rotation of the conveyor assemblies 20.

The center frame section 13 has a quick attach coupling structure 21 on its rear side for attaching to a corresponding coupling structure 22 on the self-propelled traction unit 11. The merger 10 can be uncoupled from the traction unit 11 to allow the traction unit 11 to be used with other implements, such as a swather attachment.

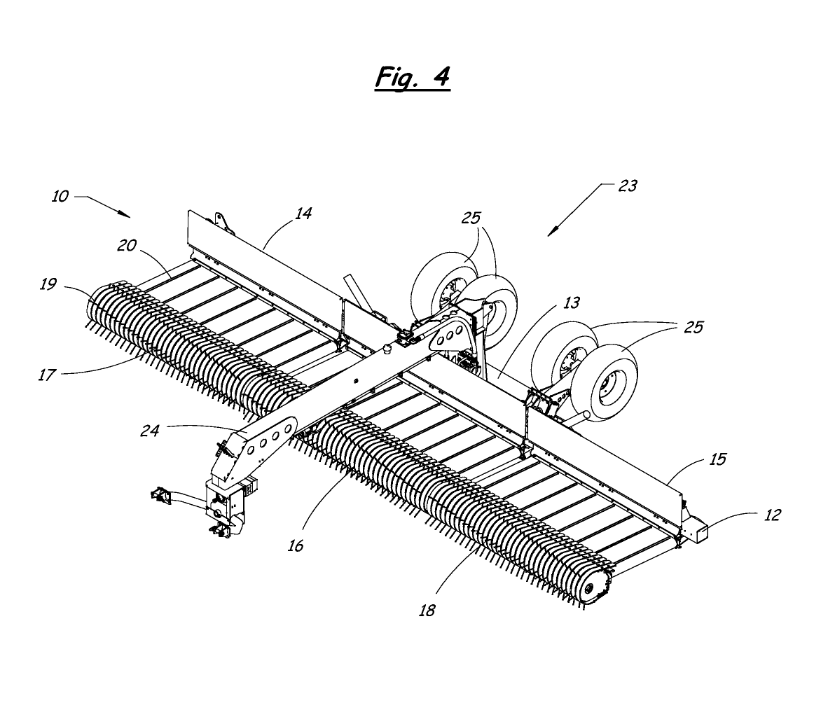

As shown in FIGS. 4 to 6, the merger 10 can also be configured for attaching behind a tractor for use as a pull-behind merger implement 23. In this configuration, a hitch tongue 24 and support wheels 25 are attached to the center frame section 13. In this manner, the merger 10 can be reconfigured easily for use as either a self-propelled merger or as a pull-behind merger implement 23. This modular design will improve the versatility and resale value of the merger 10.

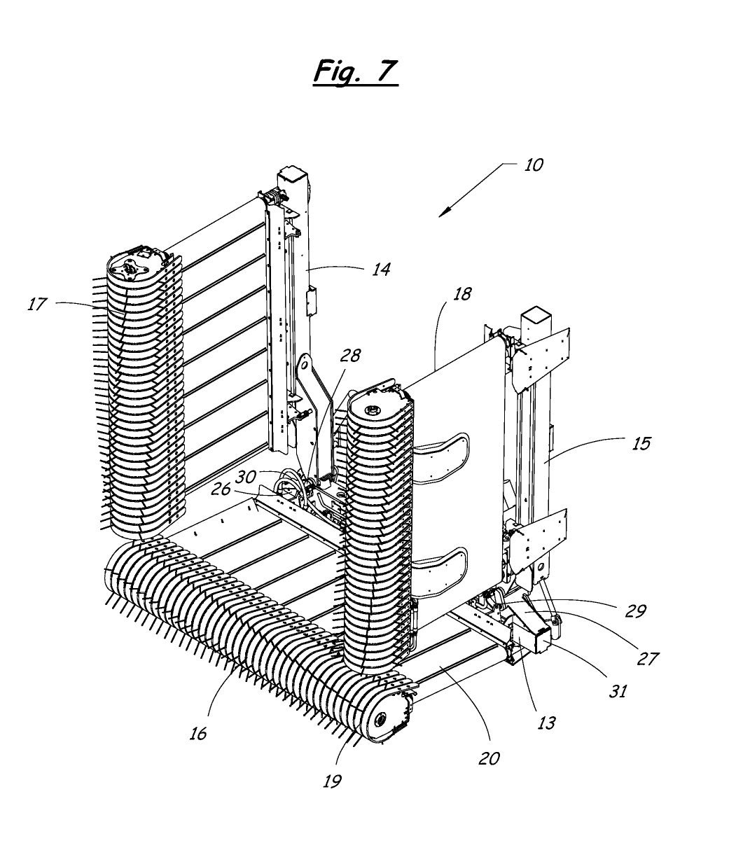

As shown in FIG. 7, the right and left wing frame sections 14, 15 are pivotally attached to the right and left sides 26, 27 of the center frame section 13, respectively, for folding movement about first and second longitudinal folding axes 28, 29. The pivot points for the first and second longitudinal folding axes 28, 29 are located inward of the outer ends 30, 31 of the center frame section 13 and above the center pickup assembly 16. First and second hydraulic cylinders 32, 33 are attached to the right and left wing frame sections 14, 15, respectively, for moving the wing frame sections 14, 15 about the first and second folding axes 28, 29.

The merger 10 has a folded configuration for transport, as shown in FIGS. 7 to 10. In the folded configuration, the right and left wing frame sections 14, 15 extend generally vertically above the center frame section 13.

The merger 10 has an unfolded configuration for field operations, as shown in FIGS. 1, 2, 4, 5 and 11. In the unfolded configuration, the right and left wing frame sections 14, 15 extend generally horizontally outwardly from outer ends 30, 31 of the center frame section 13.

Lateral folding, as provided by the merger 10, is important to fit on the front of a windrower traction unit 11 and to reduce the structure of the merger frame 12.

The lateral folding structure, including the pivot points 28, 29 and the hydraulic cylinders 32, 33, allows the merger 10 to be folded to a width under 10 feet for transport and storage. Conventional mergers have large frames at the rear to fold back and around. However, this adds weight, which increases cost and soil compaction.

Tensioner mechanisms 34 are used to maintain an appropriate amount of tension on the belts in the conveyor assemblies 20. The tensioner mechanisms 34 are provided on one of the pivot arms 35. The arm 35 pivots about the main frame 13, 14, 15 about pivot pins 36. The tensioner mechanism 34 is integrated in the pivot arm 35, and a pinned joint 36A is provided on the end to allow the tensioner mechanism 34 and pivot arm 35 to flex and allow the merger 10 to follow the contour of the ground better.

The pickup head 19 used in the merger 10 is a cam-less pickup assembly. The tines 37 of the pickup head 19 are not mounted to a bar with a cam follower that causes the tines to turn to different positions throughout the rotation of the reel, as in conventional pickup heads. Instead, the tines 37 are mounted rigid to a cylindrical tube or reel 38 and extend radially outwardly from the reel 38. The tines 37 remain perpendicular to the reel 38 throughout the rotation of the reel 38.

The tines 37 include a base portion 39 mounted rigidly to the reel 38 and a working portion 40 that extends radially outwardly from the base portion 39. The base portion 39 can be a casting adapted to fasten to the outer surface of the reel 38, or part of the tine itself. Attaching the tines 37 directly to the reel 38 in this manner reduces the number of parts in the assembly of the pickup head 19 and makes for the ability to have a pattern of tines 37 across the reel 38.

The pickup assemblies 16, 17, 18 can be cam-less in the present invention due to the unique arrangement of the conveyor assembly 20 relative to the pickup head 19. The conveyor assembly 20 is arranged with the upper surface of a draper belt 41 sloping downwardly and rearwardly from the pickup head 19. For example, the upper surface of the belt 41 can be arranged to slope downwardly and rearwardly at an angle of approximately 1 to 10 degrees relative to horizontal. In a preferred embodiment, the angle of the upper surface of the belt 41 is sloped downwardly and rearwardly approximately 3 to 7 degrees relative to horizontal.

By tipping the belt 41 down and away from the pickup head 19, the crop flow is improved from the tines 37 of the pickup head 19 to the belt 41. In contrast, having the belt flat or tipped forward has been found to impede crop flow from the pickup head to the conveyor belt. Also, having the conveyor belt 41 tipped back allows the crop to stack laterally instead of expecting the pickup head 19 to keep stacking crop vertically on top of other crop, as most conventional mergers do. The arrangement of the conveyor belt 41 relative to the pickup head 19 in the present invention results in more efficient crop flow and a smoother ending windrow.

The pickup assemblies 16, 17, 18 each have a stripper guard assembly 42 in which stationary guards 43 are spaced along a length of the reel 38 with the guards 43 positioned between adjacent paths of movement of the tines 37.

The tines 37 are arranged in a pattern across the cylindrical reel 38 so that less than one entire row of tines 37 is at bottom dead center at a time during operation. For example, the tine pattern can be such that only one tine 37 is at bottom dead center at a time. Such a pattern of tines 37 will provide a more even load on the hydraulic drive motor used to power the pickup head 19, and will also provide a more even crop flow. In contrast, a conventional pickup head typically has all the tines in a row at bottom-dead- center (highest load) at the same moment, causing uneven loading.

The cam-less pickup head 19 used in the merger 10 also reduces the number of bearings, components and weight of each pickup assembly 16, 17, 18. For example, while a conventional pickup head may have 72 bearings in just one ten foot section, the pickup head 19 of the present invention will have only 4 bearings. A drive motor 44 for rotatably driving the pickup head 19 is mounted inside the cylindrical reel 38 for conserving space.

Other embodiments of the present invention are also contemplated. For example, a merger having secondary wings attached to the right and left wing sections 14, 15 can be made using the lateral folding structure of the present invention. This would allow the merger to have up to five sections that can reach out to 50 feet total width. The present invention also has the potential to allow dealers to reconfigure mergers to change operating widths using bundles to make machines wider to fit various customer needs. The lateral folding of the present invention will also allow the merger 10 to be adapted to reverse station tractors or other power units.

While the invention has been specifically described in connection with specific embodiments thereof, it is to be understood that this is by way of illustration and not of limitation, and the scope of the appended claims should be construed as broadly as the prior art will permit.

What is claimed is:

1. A windrow merger comprising:
a frame having a center frame section and right and left wing frame sections, said right wing frame section being pivotally attached to a right side of said center frame section for folding movement about a horizontal first longitudinal folding axis, and said left wing frame section being pivotally attached to a left side of said center frame section for folding movement about a horizontal second longitudinal folding axis;
a center pickup assembly comprising a pickup head and conveyor assembly supported by said center frame section;
a right wing pickup assembly comprising a pickup head and conveyor assembly supported by said right frame section; and
a left wing pickup assembly comprising a pickup head and conveyor assembly supported by said left frame section;
said merger having an unfolded configuration for field operations in which said right and left wing frame sections extend generally horizontally outwardly from outer ends of said center frame section, and a folded configuration in which said right and left wing frame sections extend generally vertically above said center frame section.

2. The windrow merger according to claim 1, wherein pivot points for said first and second longitudinal folding axes are located inward of the outer ends of said center frame section and above said center pickup assembly.

3. The windrow merger according to claim 2, further comprising first and second hydraulic cylinders attached to said right and left wing frame sections, respectively, for moving said wing frame sections about said first and second folding axes.

4. A windrow merger comprising:
a frame having a center frame section and right and left wing frame sections, said right wing frame section having an inner end and an outer end and being pivotally attached to a right side of said center frame section for folding movement about a horizontal first longitudinal folding axis, and said left wing frame section having an inner end and an outer end and being pivotally attached to a left side of said center frame section for folding movement about a horizontal second longitudinal folding axis;
a center pickup assembly comprising a pickup head and conveyor assembly supported by said center frame section;
a right wing pickup assembly comprising a pickup head and conveyor assembly supported by said right frame section; and
a left wing pickup assembly comprising a pickup head and conveyor assembly supported by said left frame section;
said merger having an unfolded configuration for field operations in which said right and left wing frame sections extend generally horizontally outwardly from outer ends of said center frame section, and a folded configuration in which said right and left wing frame sections extend generally vertical and perpendicular to said center frame section with the outer ends of said right and left wing frame sections vertically above the inner ends thereof.

5. The windrow merger according to claim 4, wherein pivot points for said first and second longitudinal folding axes are located inward of the outer ends of said center frame section and above said center pickup assembly.

6. The windrow merger according to claim 5, further comprising first and second hydraulic cylinders attached to said right and left wing frame sections, respectively, for moving said wing frame sections about said first and second folding axes.

7. A convertible windrow merger comprising:
a frame;
a pickup assembly comprising a pickup head and conveyor assembly supported by said frame; and
a means for converting said frame between a first configuration for attaching to a front of a self-propelled traction unit for use as a self-propelled merger, and a second configuration for attaching behind a tractor for use as a pull behind merger.

8. The convertible windrow merger according to claim 7, wherein said second configuration comprises a hitch tongue and support wheels attached to said frame.

9. The convertible windrow merger according to claim 7, wherein said first configuration comprises a quick attach coupling structure for attaching to a corresponding coupling structure on a self-propelled traction unit.
